(19) United States
(12) Patent Application Publication
(10) Pub. No.: US 2023/0129290 A1
(43) Pub. Date: Apr. 27, 2023

(54) INTERPRETABLE FORECASTING USING PATH STATE TRANSITIONS IN APPLICATION DRIVEN PREDICTIVE ROUTING

(71) Applicant: Cisco Technology, Inc., San Jose, CA (US)

(72) Inventors: Vinay Kumar Kolar, San Jose, CA (US); Jean-Philippe Vasseur, Saint Martin d'Uriage (FR)

(21) Appl. No.: 17/507,448

(22) Filed: Oct. 21, 2021

(51) Int. Cl. H04L 12/24

(52) U.S. Cl. CPC H04L 41/5038; H04L 41/145; H04L 41/147

(57) ABSTRACT

In one embodiment, a device computes states of a network path associated with an online application by representing time series of telemetry data regarding the network path as discrete values. The device makes, using a machine learning model, a prediction that a quality of experience metric for the online application will be degraded, based on a particular transition pattern of the states being observed for the network path. The device determines one or more performance metrics for the machine learning model with respect to the network path. The device provides an indication of the particular transition pattern of the states for display, based in part on the one or more performance metrics for the machine learning model with respect to the network path.

### TECHNICAL FIELD

The present disclosure relates generally to computer networks, and, more particularly, to interpretable forecasting using path state transitions in application driven predictive routing.

### BACKGROUND

Software-defined wide area networks (SD-WANs) represent the application of software-defined networking (SDN) principles to WAN connections, such as connections to cellular networks, the Internet, and Multiprotocol Label Switching (MPLS) networks. The power of SD-WAN is the ability to provide consistent service level agreement (SLA) for important application traffic transparently across various underlying tunnels of varying transport quality and allow for seamless tunnel selection based on tunnel performance characteristics that can match application SLAs and satisfy the quality of service (QoS) requirements of the traffic (e.g., in terms of delay, jitter, packet loss, etc.).

With the recent evolution of machine learning, predictive failure detection and proactive routing in an SDN/SD-WAN now becomes possible through the use of machine learning techniques. For instance, modeling the delay, jitter, packet loss, etc. for a network path can be used to predict when that path will violate the SLA of the application and reroute the traffic, in advance. However, these models usually do not capture early warnings signs because many early warning signs are weak in nature and traditional machine learning models are not capable of recognizing such warning signs (e.g., due to their transitory natures, etc.). As a result, many predictive failure detection and proactive routing systems are unable to provide interpretable reasons for their actions to a network administrator.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for interpretable forecasting using state transitions in application driven predictive routing;

FIG. 6 illustrates an example plot of performance metrics for a prediction model;

FIG. 7 illustrates an example plot of precision and recall for a prediction model across different network paths;

FIG. 8 illustrates an example cluster map of network paths;

FIG. 9 illustrates another example cluster map of network paths;

FIG. 10 illustrates an example plot of true positive and false positives triggered by a particular state transition pattern;

FIG. 11 illustrates an example plot of a quality of experience metric versus network path metrics;

FIG. 12 illustrates an example user interface showing multiple state transition patterns over time; and

FIG. 13 illustrates an example simplified procedure for performing interpretable forecasting using state transitions in application driven predictive routing.

### DESCRIPTION OF EXAMPLE EMBODIMENTS

### Overview

According to one or more embodiments of the disclosure, a device computes states of a network path associated with an online application by representing time series of telemetry data regarding the network path as discrete values. The device makes, using a machine learning model, a prediction that a quality of experience metric for the online application will be degraded, based on a particular transition pattern of the states being observed for the network path. The device determines one or more performance metrics for the machine learning model with respect to the network path. The device provides an indication of the particular transition pattern of the states for display, based in part on the one or more performance metrics for the machine learning model with respect to the network path.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

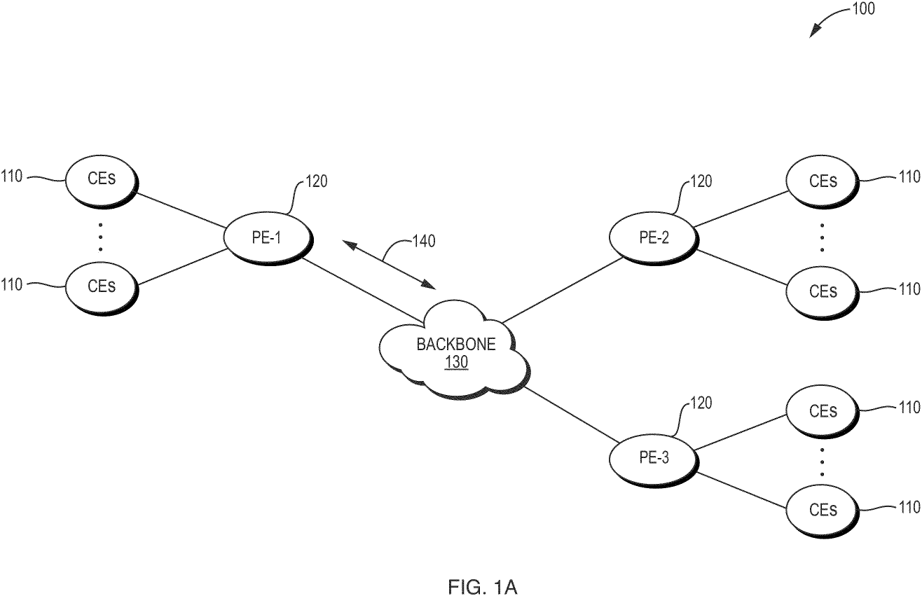

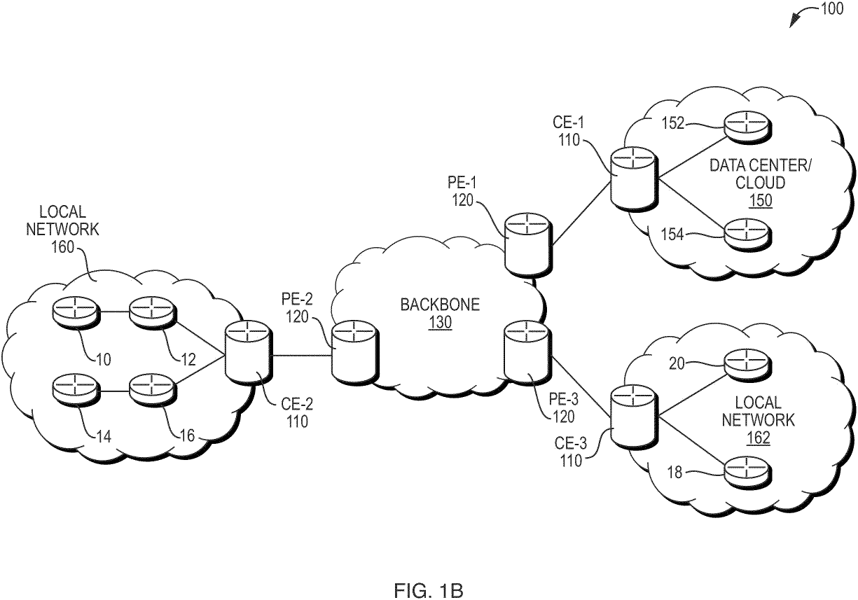

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).
   Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

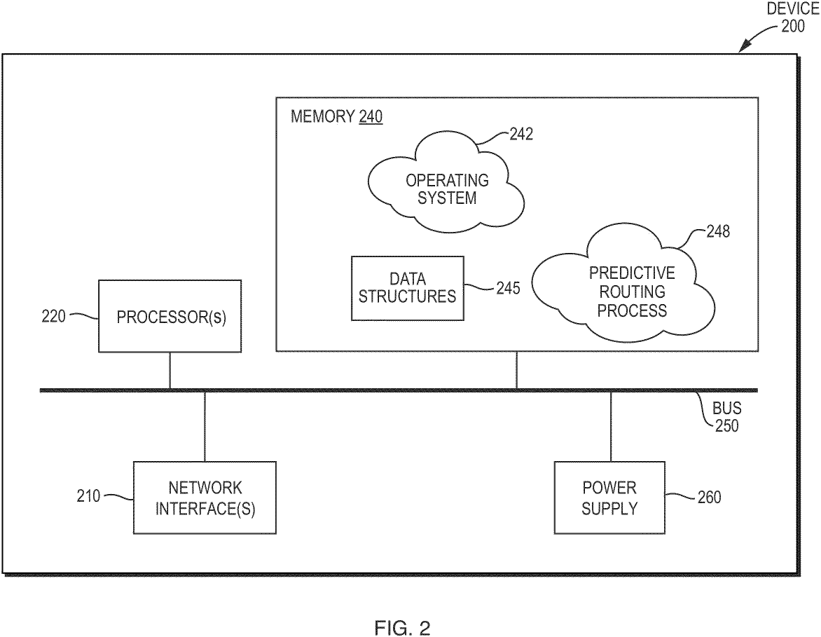

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a predictive routing process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, predictive routing process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc.

In various embodiments, as detailed further below, predictive routing process 248 may include computer executable instructions that, when executed by processor(s) 220, cause device 200 to perform the techniques described herein. To do so, in some embodiments, predictive routing process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M = a^{∗}x + b^{∗}y + c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, predictive routing process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that predictive routing process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

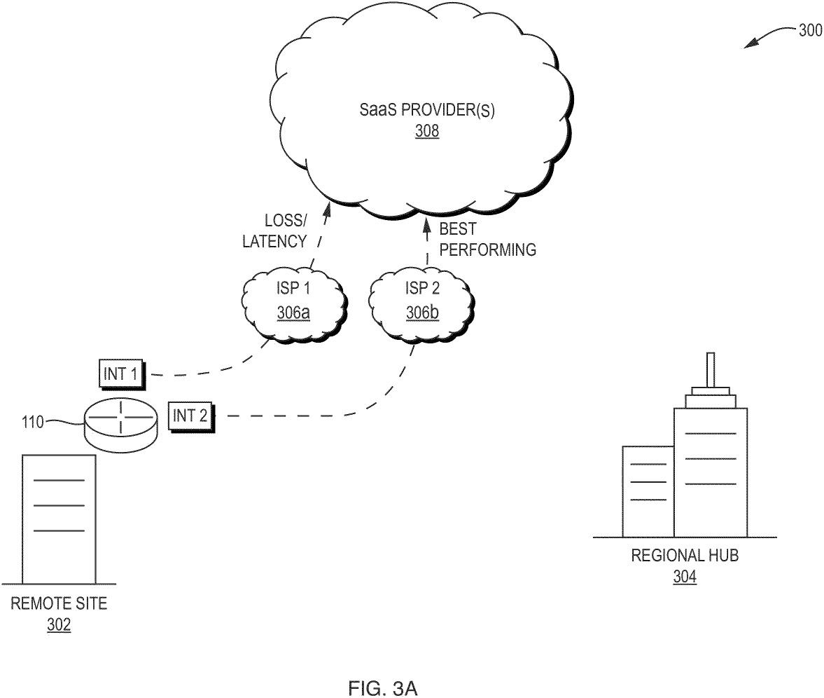

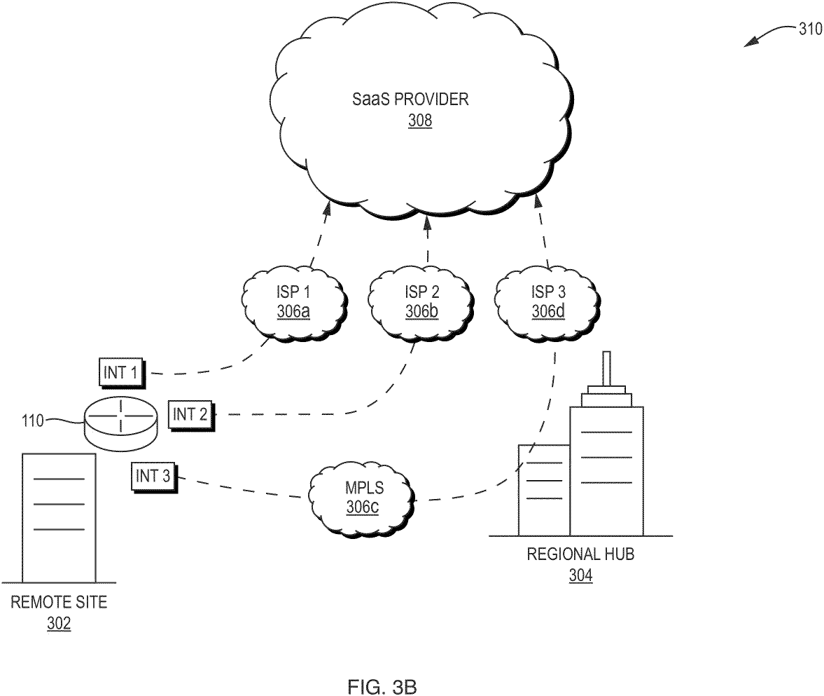

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

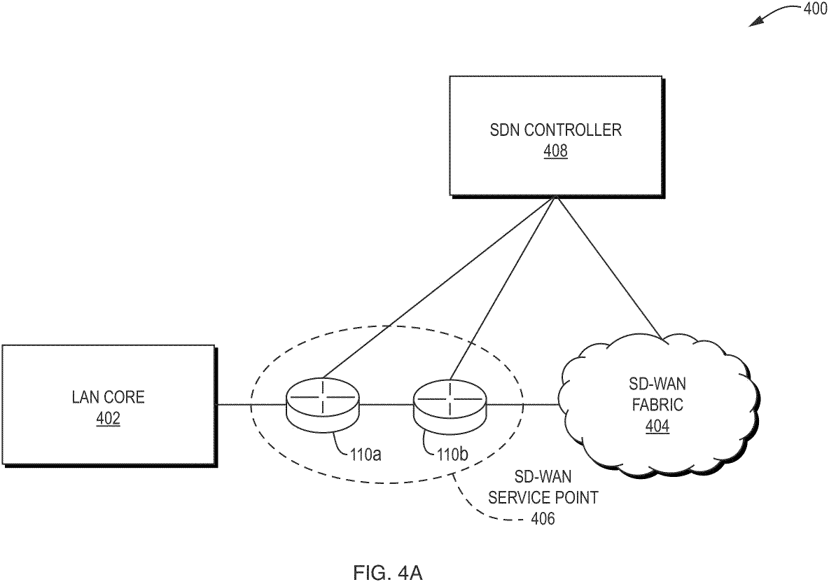

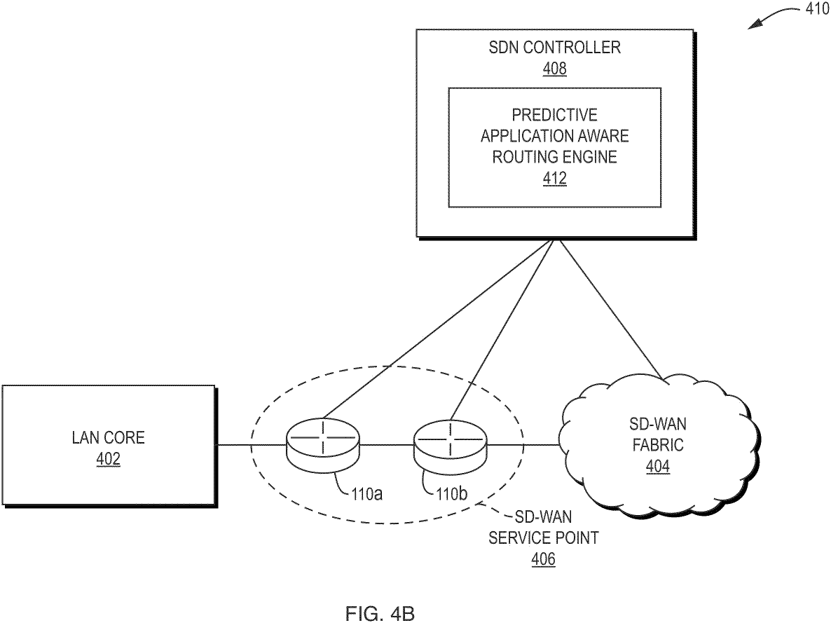

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. for instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multicloud SaaS.

Furthermore, the level of dynamicity observed in today’s network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application’s traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of predictive routing process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, application-driven/aware predictive routing systems may forecast that a particular path will provide bad application experience and reroute its traffic, accordingly. One of the core components of such a system is the forecasting engine which is responsible for predicting that a path will lead to degraded application experience.

Traditionally, network forecasting engines usually employ traditional time-series regression or classification models to predict the performance of the path in the future. While such models help in predicting, they usually do not capture early signs. Indeed, many early signs are weak in nature. For example, the jitter along a path may fluctuate between 0 and 5 ms or the loss may oscillate between 0.1 and 0.3%. However, after a few minutes, the path may begin to provide bad QoE to the users of the application by, say, exhibiting very high loss or jitter. For networking experts, this explains the instability in the path (jitter fluctuations) either due to congestion buildup at the edge routers, or early warning policies being triggered at the core routers. However, a simple regression model will most likely ignore such small fluctuations because such models do not capture these types of early warning signs. Hence, it cannot use those features for either enhancing accuracy, or for providing intuitive explanations on why decisions were taken by the forecasting engine.

### Interpretable Forecasting Using Path State Transitions in Application Driven Predictive Routing

The techniques introduced herein allow for interpretable network forecasting by using state-transition forecasting models to build predictive, application-driven routing systems. In some aspects, the system may first identify the states of the path by analyzing the path metrics, such as (but not limited to) loss and jitter metrics. More specifically, the states may be represented such that relevant fluctuations, however small they might be, are captured as different states. In further aspects, the techniques herein may then utilize the trajectory of transitions between the states to extract the early signs that may lead to a bad application experience. Said differently, the techniques herein allow for the learning of trajectories across states capable of predicting failures (e.g., actual drops in reported QoE, SLA violations, etc.). In further aspects, the forecasting engine may utilize such early signs to forecast the probability of bad application experience, which allows the system to rely on weak and/or transitory early signs for detection, as well as providing explainable models that can reason why the path is providing a bad application experience. In another aspect, the techniques herein are flexible and such a model can be used in a cloud or on-the-edge, to detect and forecast degradation of the application experience.

Illustratively, the techniques described herein may be performed by hardware, software, and/or firmware, such as in accordance with predictive routing process 248, which may include computer executable instructions executed by the processor 220 (or independent processor of interfaces 210) to perform functions relating to the techniques described herein.

Specifically, according to various embodiments, a device computes states of a network path associated with an online application by representing time series of telemetry data regarding the network path as discrete values. The device makes, using a machine learning model, a prediction that a quality of experience metric for the online application will be degraded, based on a particular transition pattern of the states being observed for the network path. The device determines one or more performance metrics for the machine learning model with respect to the network path. The device provides an indication of the particular transition pattern of the states for display, based in part on the one or more performance metrics for the machine learning model with respect to the network path.

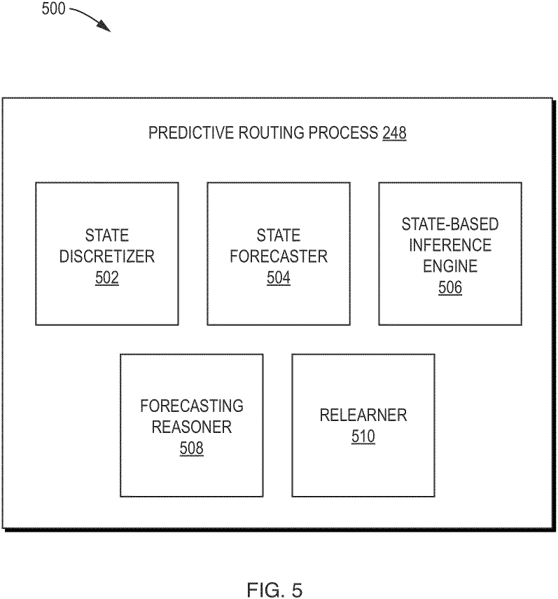

Operationally, FIG. 5 illustrates an example architecture 500 for interpretable forecasting using state transitions in application driven predictive routing, according to various embodiments. At the core of architecture 500 is predictive routing process 248, which may be executed by a controller for a network or another device in communication therewith. For instance, predictive routing process 248 may be executed by a controller for a network (e.g., SDN controller 408 in FIGS. 4A-4B), a particular networking device in the network (e.g., a router, etc.), another device or service in communication therewith, or the like. In some embodiments, for instance, predictive routing process 248 may be used to implement a predictive application aware routing engine, such as predictive application aware routing engine 412.

As shown, predictive routing process 248 may include any or all of the following components: a state discretizer 502, state forecaster 504, a state-base inference engine 506, a forecasting reasoner 508, and/or a relearner 510. As would be appreciated, the functionalities of these components may be combined or omitted, as desired. In addition, these components may be implemented on a singular device or in a distributed manner, in which case the combination of executing devices can be viewed as their own singular device for purposes of executing predictive routing process 248.

During operation, state discretizer 502 may obtain various telemetry data regarding the network path(s) under scrutiny by predictive routing process 248. For instance, such telemetry data may take the form of path metrics (e.g., delay, jitter, packet loss, throughput, etc.), NetFlow records, application data (e.g., traffic load, destination, etc.), or the like. For instance, in the case of actual QoE metrics being available, state discretizer 502 may receive them from a provider of an online application. In other instances, state discretizer 502 may use SLA violations as a proxy for the QoE.

According to various embodiments, state discretizer 502 may represent the various telemetry time series that it obtains using discrete values. For instance, state discretizer 502 may use the symbol set of {a, b, c, z} to represent the discrete categories of delay, jitter, packet loss, etc., where a=low, b=medium, c=high, and z=SLA violation along a path P at a time t. Doing so allows the state of any given network path to be represented as a vector of discrete values.

In various embodiments, predictive routing process 248 may also include state forecaster 504, which is responsible for both forecasting and explaining the state of a path at a future time. In one embodiment, state forecaster 504 may collect the sequence of states in the last k-number of timesteps from state discretizer 502, to make its predictions. For instance, state forecaster 504 may represent the state of a path P for application class A at time t is represented as S(P, A, t) = <probSlaViolationState, latencyState, lossState, jitterState>, where each individual state is a symbol from the set of discrete values {a,b,c,z} above.

Note that the selected features/types of data used in the vectorized state representations can vary. For instance, in the above example, the path state may be a function of features: probability of SLA violation, loss, latency and jitter. However, other combinations of features could also be used, in other embodiments. In addition, further embodiments also provide for different sets of discrete values and the use of {a, b, c, z} (i.e., four possible states) herein is for exemplary purposes only.

In general, state forecaster 504 is operable to find a sequence of patterns of the states referred to as state-trajectories that can predict an SLA violation or other metric indicative of degraded application QoE. In one embodiment, state forecaster 504 may look at last k-timesteps of states [S(P, A, t-k), ..., S(P, A, t-1)] and predict S′(P, A, t). This number of last states being examined (k) can also be configured by a user, in one embodiment.

State forecaster 504 can be implemented using any number of suitable data mining algorithms, like sequential pattern mining (e.g., PrefixSpan), which finds out the subsequence of states that are of interest. The algorithm will first input set of positive k-states, i.e., all sequences of states [S(P, A, t-k), ..., S(P, A, t-1)] where S(P, A, t) is the start of an SLA violation (rising edge). In turn, it may output a subsequence/state-trajectory of [SA-...-SB-...SC] that are prominently found in the set of positive k-states. For example, the algorithm may output [aabc, aabc, accc] to have a support of 30% meaning that 30% of all rising edges had state [^{∗}, aabc, ^{∗}, aabc, ^{∗}, accc,^{∗}]. Said differently, the support is indicative of the predictive power of such as trajectory of states. Note that the support provides the “recall” metric for the subsequence, i.e., the fraction of rising edges which are detected by a subsequence.

State forecaster 504 may use the above step to detect the subsequences/state transition patterns that commonly occur when there is a rising edge (e.g., an SLA violation) since the input data is the subset for rising edges only. However, such a pattern might be common even when there are no rising edges. For example, the subsequence [aaaa,^{∗}, aaaa] might be common for times when there are rising edges, and also during times when there are no rising edges. If such subsequences are pruned, state forecaster 504 will predict a lot of false positives, since such subsequences occur frequently. Accordingly, state forecaster 504 may also perform pruning of subsequences/patterns that result in false positives, in further embodiments.

In one embodiment, state forecaster 504 may rely on the following metrics to prune patterns susceptible to providing false positives:
For each subsequence S_i selected, we compute the number of rows in the entire dataset that match the subsequence.
Positive or Negative: Each row in the dataset also be tagged as a positive or negative depending on if there is a rising edge in the next 10 minutes. Based on the above two metrics

State forecaster 504 can then use the above two metrics to compute any or all of the following model performance metrics:
True positives (TP) for a sub-sequence : Num rows in the entire dataset where the sequence was a part of last 6-states, and the next-state is a rising edges
False positives (FP) for a subsequence: Num rows in the entire dataset where the sequence was present in the last 6-states, but the next state was not a rising edge
Precision = TP/(TP + FP)

State forecaster 504 can then use the precision metric to select what are referred to herein as the “prominent subsequences” (PS) that will finally be used to trigger rising edge. In one embodiment, state forecaster 504 may only select those subsequences/patterns as PS that have a precision greater than a defined threshold, which may be set by default or by a user.

In other embodiments, instead of state forecaster 504 evaluating the full path state (e.g., <a, c, c, c>), it may decompose such a state into univariate states. For example, “lb”, “da,” and “jc” implies loss is in state “b,” latency (delay) is in state “a,” and jitter is in state “c.”

In various embodiments, predictive routing process 248 may also include state-base inference engine 506, which is responsible for using the Prominent Subsequences (PS) from state forecaster 504 and forecast whether a degradation in the application experience is upcoming (e.g., an upcoming SLA violation, etc.). To do so, state-base inference engine 506 may not only predict when a rising edge occurs (which is usually given by the above Prefix-Span algorithm), but also when to keep predicting that such a condition will continue.

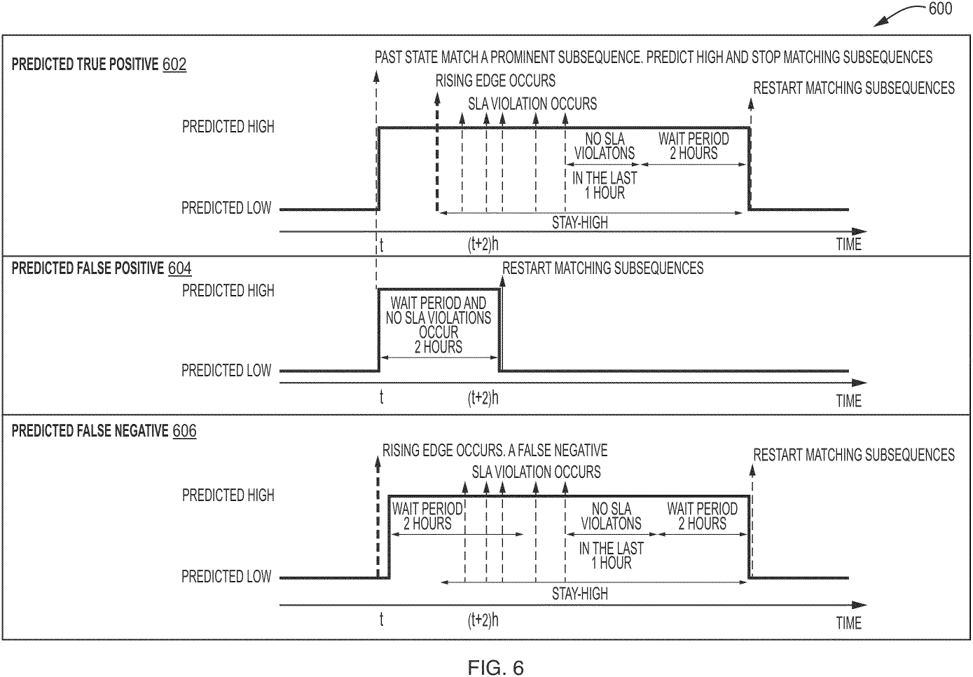

By way of example, FIG. 6 illustrates an example plot 600 of performance metrics for the prediction model of state-base inference engine 506. As shown, plot 600 includes the time series for the following metrics regarding the predictions: the true positives 602, the false positives 604, and the false negatives 606. During execution, at each time step t, state-base inference engine 506 may examine the past n-number of path states and predict whether the next state is a rising edge. This can be achieved by matching the last n-number of states to the prominent subsequence (PS) for that path. Accordingly, if any of the PS patterns are matched, state-base inference engine 506 may enter into an SLA violation “HIGH” state, where it is expected that a rising edge will occur within a certain amount of time (e.g., five minutes) from time t.

In some embodiments, state-base inference engine 506 may also utilize a wait period parameter that controls how it assumes its prediction to hold true. More specifically, state-base inference engine 506 may perform the following with respect to the different model performance metrics:
Predicted True Positive 602: If there is a rising edge before the wait period, then state-base inference engine 506 may tag the call at t as a True Positive. May then start a wait period time for a certain amount of time, such as for one hour. If an SLA violation occurs within that next hour, it will reset the timer and wait for a further hour. However, if the wait period timer expires without an SLA violation being observed, state-base inference engine 506 may wait for a further wait period (e.g., a ‘cooling off’ period) of two hours. If, again there is no SLA violation in this period of time, state-base inference engine 506 may return to a “LOW” state and start matching the patterns for the last n-number of states, to predict the next rising edge.
Predicted False Positive 604: If the rising edge does not occur during the wait period, state-base inference engine 506 may tag the call at t as a False Positive, and will return to Low state and begin inferring that the path will not have an SLA violation.
Predicted False Negative 606: There might be scenarios where the inference algorithm is in the predicted Low state, yet a rising edge still occurs at time t. In such a case, it is a False Negative (FN) at time t. Upon detecting a FN at time t, state-base inference engine 506 may go into a reactive mode, and switch to a ‘HIGH’ state, since more SLA violations may follow. In such a state, it may observe the same rules as with the “HIGH” state for the predicted true positives 602.

Using the above metrics in test data inference, state-base inference engine 506 can also compute the precision and recall of the algorithm with respect to the specific network path and online application. In some embodiments, state-base inference engine 506 may also apply its state-transition algorithm only to paths which have high precision (say, > 0.8) and recall (say, > 0.6).

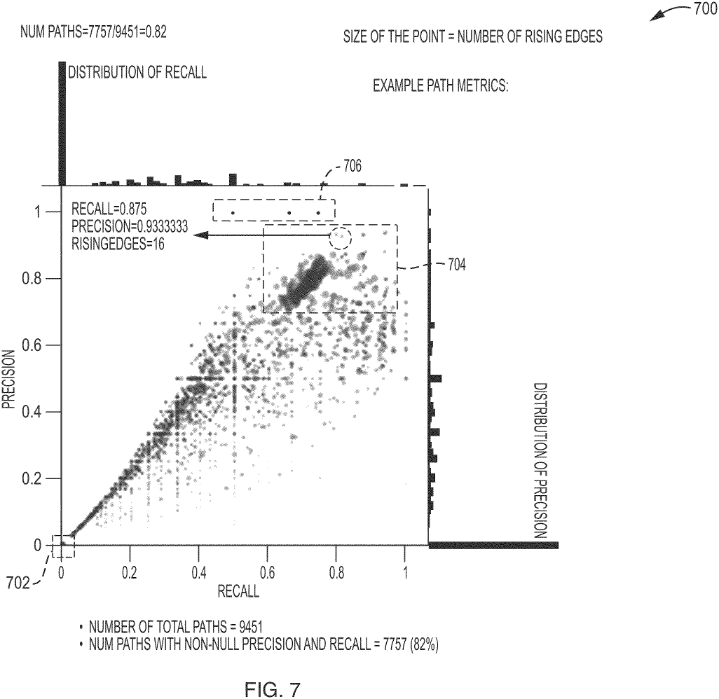

For example, FIG. 7 illustrates an example plot 700 of precision and recall for a prediction model across different network paths, according to various embodiments. More specifically, the computed precision of the model for a given network is plotted on the Y-axis and the recall on X-axis. Each dot in plot 700 represents one path and the size of dot shows the number of rising edges seen for the test dataset for that path. The paths that will be finally enabled by state-base inference engine 506 to predict rising edges will be the ones with precision > 0.8 and recall > 0.6, or above other thresholds, which may be user-defined. For other paths, the chances that state forecaster 504 is effective are very low, and hence rising edges for such paths will not be predicted.

Here, plot 700 may be provided for display to a user by predictive routing process 248, so that the user can review how its machine learning model performs for the various network paths for a certain online application. At region 702, for instance, it can be seen that 3,915 out of a total number of 9,451 paths exhibit a recall and precision of zero.

In addition, region 704 of plot 700 shows that there are some paths with a high number of rising edges (e.g., ~50-90 rising edges in 24 days), which were detected with a precision > 0.7 and recall > 0.6. For the other network paths, the chances that state forecaster 504 will be effective are low and, in some embodiments, rising edges for these paths may not be predicted.

Region 706 also indicates that there were a few network paths for which the model had a precision of 1.0, but exhibited only a very low number of rising edges (e.g., 3-4 in 24 days). Recall for these paths was also fairly low, with only 1-2 of the rising edges being true positives.

In addition to choosing paths for which the precision and recall of the model exceed acceptable threshold, the user may also have an option to select the paths where the ‘depth’ of the states is such that it gives enough time for system to react. For example, instead of using the default last k-number of states, the user may specify to only keep subsequences from time (t-k) to (t-delta) for detection. This is the time delay delta that the system must wait to predict the rising edge. Such depth times may be used since there is typically a delay between the inference algorithm and the system to react to the predicted SLA violation. In such cases, user may select paths (and prominent subsequences) only where the depth of subsequences in PS is greater than a certain value delta.

Referring again to FIG. 5, predictive routing process 248 may also include forecasting reasoner 508, which is responsible for providing information to a user interface as to why the system predicted a certain state, the prominent paths that have early subsequences before rising edge, and/or the common trajectory of states the path goes through before hitting a rising edge. For instance, forecasting reasoner 508 may provide display data indicative of this information to an electronic display for review by a network administrator. For instance, forecasting reasoner 508 may provide plot 700 for display from which a user can see and select paths that have high precision and recall.

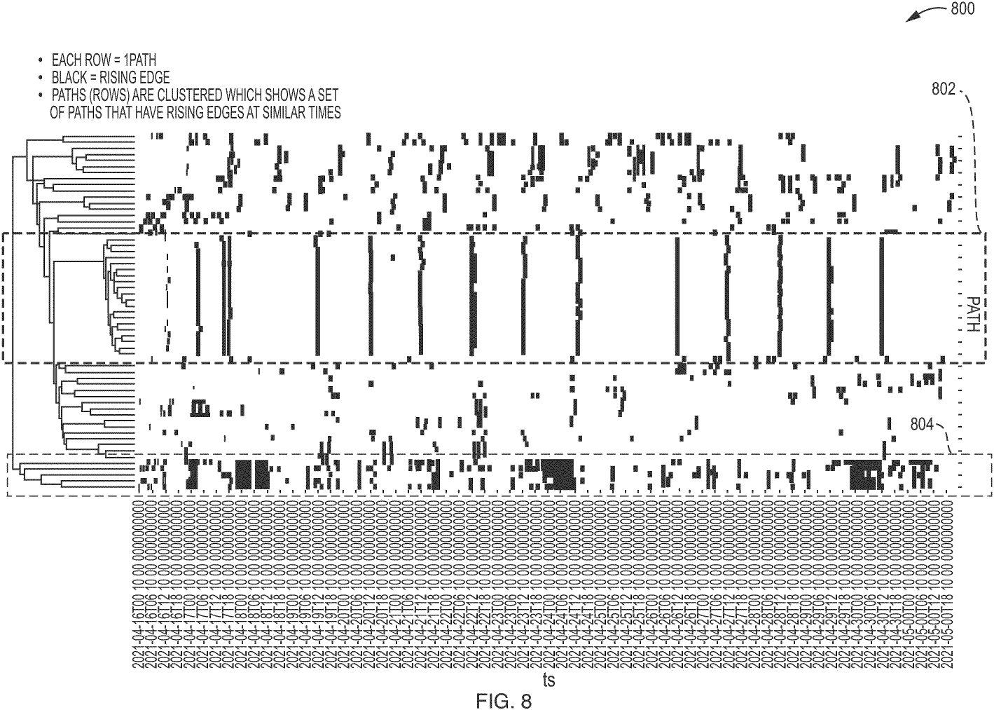

In other embodiments, forecasting reasoner 508 may show all the paths that have rising edge at the same times. For instance, forecasting reasoner 508 may provide a cluster map for display, such as cluster map 800 shown in FIG. 8. As shown, each row (Y-axis) is a path, and the X-axis shows the time-frame. The black dots show where the rising edge occurs. The user may also have options to select “all paths” or “paths where state-base inference engine 506 and/or forecasting reasoner 508 was employed” (e.g., paths where precision and recall were high).

Through analysis of cluster map 800, two clusters become apparent: cluster 802 and cluster 804. Here, cluster 802 includes a plurality of paths whose rising edges happen several times a day. Moreover, all of the paths in cluster 802 exhibit rising edges at, or around, the same times. This is a strong indication to the user that the QoE degradations along these paths are related, in some way.

Cluster 804 represents another set of paths whose rising edges happen often and in bursts. This means that these paths exhibit a very different behavioral pattern than those in cluster 802.

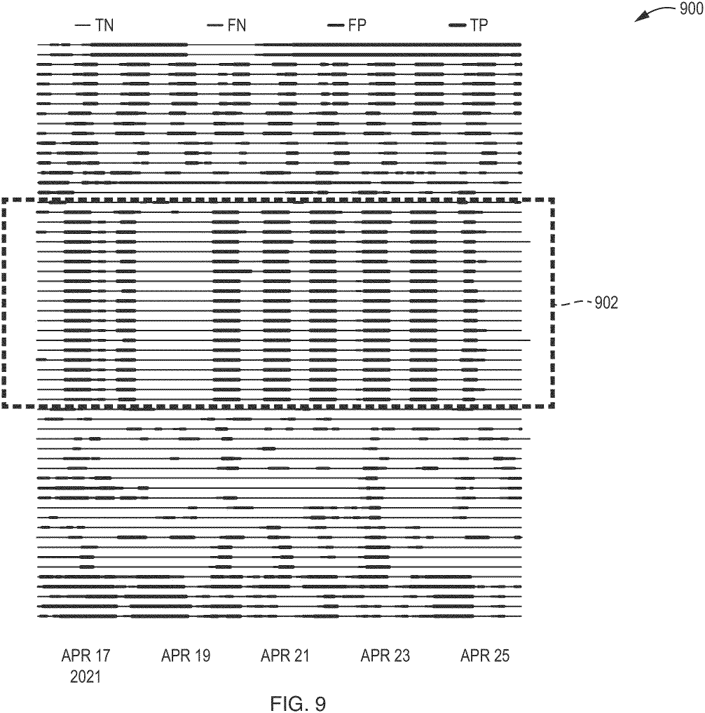

FIG. 9 illustrates another cluster map 900 that forecasting reasoner 508 may present for display to a user, in various embodiments. In this instance, the true positive (TP), true negative (TN), false positive (FP), and false negative (FN) rates for the various paths may be represented in cluster map 900, based on whether the inference algorithm predicted the SLA violation period/period of degradation, not just the rising edge. From this, it can be seen that cluster 802 includes paths that all had rising edges together and had similar SLA violation periods that were often predicted with high precision and recall, indicating that these paths are related.

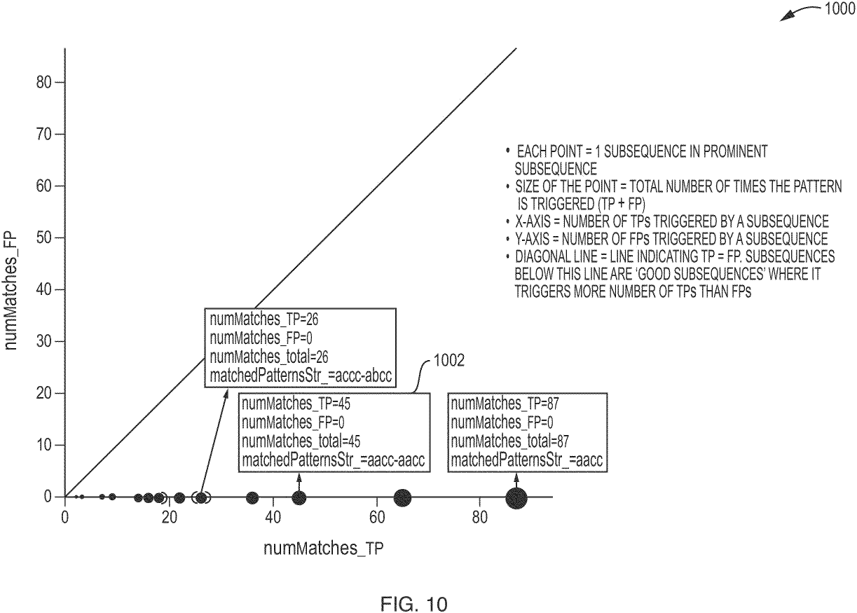

In some embodiments, a user may choose a particular path of interest by interacting with any of plots 700-900, which may present additional information about the early signs seen in the path. For instance, FIG. 10 illustrates an example plot 1000 of true positive and false positives triggered by a particular state transition pattern and may be displayed by forecasting reasoner 508 when a particular path is selected.

As shown in FIG. 10, each point in plot 1000 represents a subsequence in the prominent subsequence (e.g., state transition pattern) leading up to a rising edge, with the x-axis plotting the number of TPs triggered by a subsequence and the y-axis plotting the number of FPs triggered by that subsequence. The size of each point is also a function of the total times the pattern is triggered. The diagonal line in plot 1000 indicates the condition whereby TP=FP. Thus, subsequences below this line are ‘good’ subsequences, meaning that there are more TPs than FPs.

From plot 1000, it is quite easy to see early signs of when the path exhibits SLA violation, through the display of annotation boxes associated with the different plotted points. For instance, box 1002 shows that the sequence “^{∗}-aacc-^{∗}-aacc-^{∗}” (meaning high values of latency and jitter) are often the causes for breaking SLA violation in the next few hours.

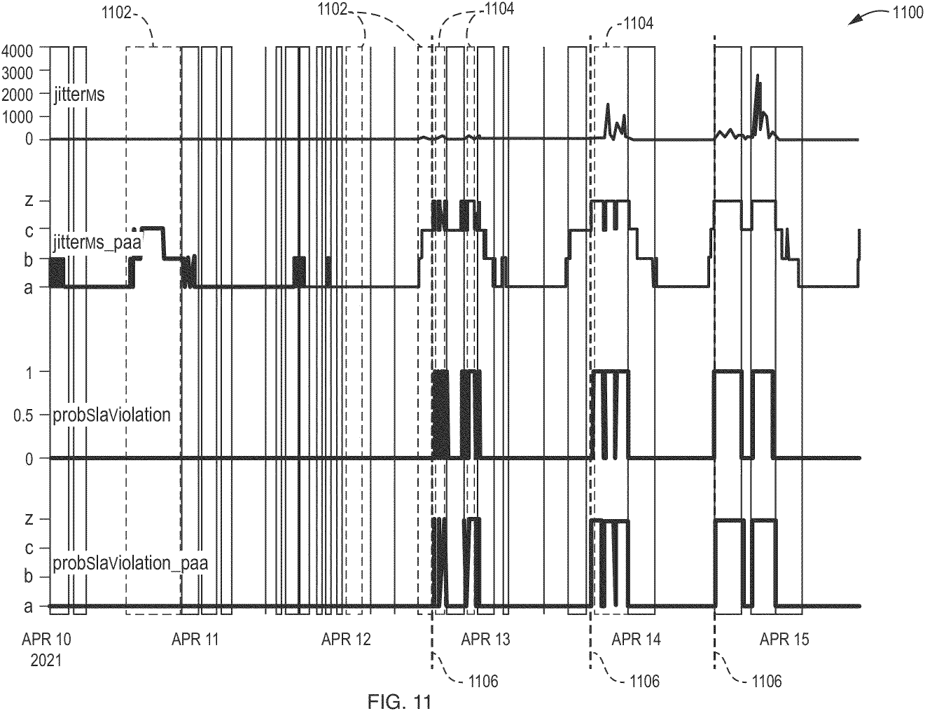

In some embodiments, the interface may also show the time-series of bad application experience (e.g., probSlaViolation), and QoS metrics that have early signs of degradation (e.g., jitter in the above case). For instance, FIG. 11 illustrates an example plot 1100 of a quality of experience metric versus network path metrics that may also be displayed to the user. As shown, various metrics, such as jitter and the probability of an SLA failure are plotted in plot 1100.

In addition, plot 1100 may include different indicia, to represent conditions under which the early signs were detected (e.g., shading 1102) and when the application experience was degraded (e.g., shading 1104). For instance, say that the path states are vectorized as <probSLAviolation, loss, latency, jitter> (e.g., <z,b,c,z> represents an SLA violation, with medium loss, high latency, and an SLA violation by the jitter). Here, the ‘hint’ states/early signs are those states with some (^{∗}b^{∗}) or (^{∗}c^{∗}), but no actual SLA violation, which may be indicated by shading 1102. In this instance, states with (^{∗}c^{∗}) but no SLA violation constitute severe hint states.

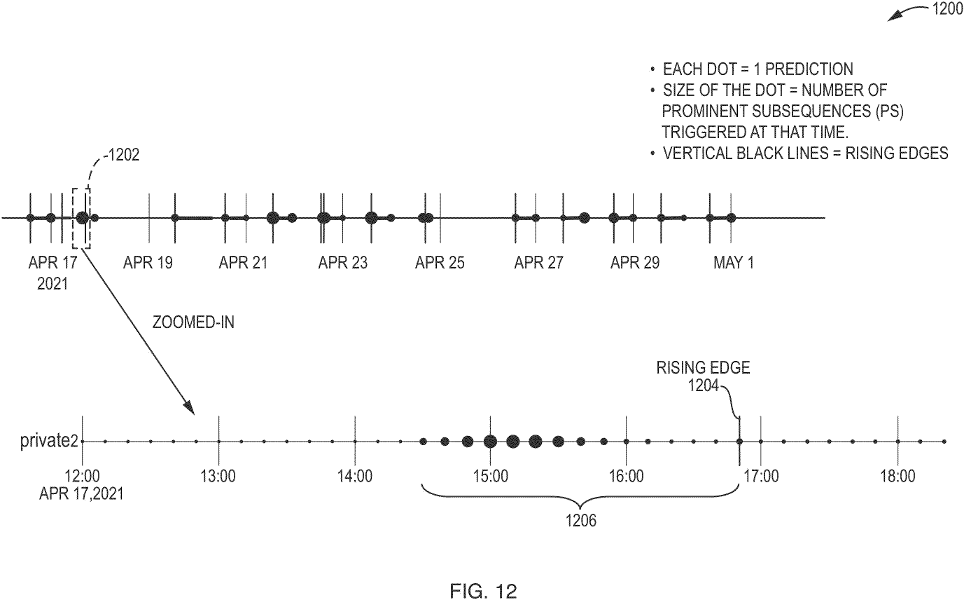

FIG. 12 illustrates yet an example user interface 1200 that may be provided by display by forecasting reasoner 508. Here, interface 1200 may show multiple state transition patterns over time, such as a timeline in which each dot represents a single prediction. The size of a dot represents the number of prominent subsequences triggered at that time. In addition, the vertical lines of the timeline also represent rising edges.

In one embodiment, the user may interact with any of the dots, to zoom-in on that prediction. For instance, as shown, if the user selects dot 1202, the system may zoom-in on that portion of the timeline. From this, it can be seen that there are early signs 1206 that were matched approximately 2.5 hours prior to rising edge 1204. These early signs may be a result of queue build up in the edge routers or some other phenomenon that is causing rising edge 1204. Based on such temporal evolution, the user can select when to react to the rising edge. For example, in this example, the user may look at the information provided via the interface and configure a wait period of 3 hours for the inference algorithm after early patters are detected, rather than a default wait period of 2 hours.

Referring yet again to FIG. 5, predictive routing process 248 may also include relearner 510, according to various embodiments. In general, relearner 510 is responsible for monitoring the state of the rising edges and predictions, and will trigger the state forecaster to relearn when the pattern of the state changes. This can be done in several ways. In one embodiment, the system will monitor the cut-off values for “a,” “b,” and “c” in state discretizer 502. Note that this is usually dynamically chosen based on transforms such as z-norms.

If the value of QoS mapping to a, b or c changes significantly (e.g., more than 20%), then releaerner 510 can trigger relearn messages to: a.) state-base inference engine 506 to stop predicting for that path and b.) state forecaster 504 to trigger model training again. In other embodiments, relearner 510 may monitor the precision, recall, TPs, FPs and FNs for a path. If it changes significantly, relearner 510 may initiate similar relearn messages. In yet another embodiment, a path trace can be analyzed by tools such as ThousandEyes or other path monitoring utilities. If the path is going over different set of Autonomous Systems (AS), then the relearn messages can be sent.

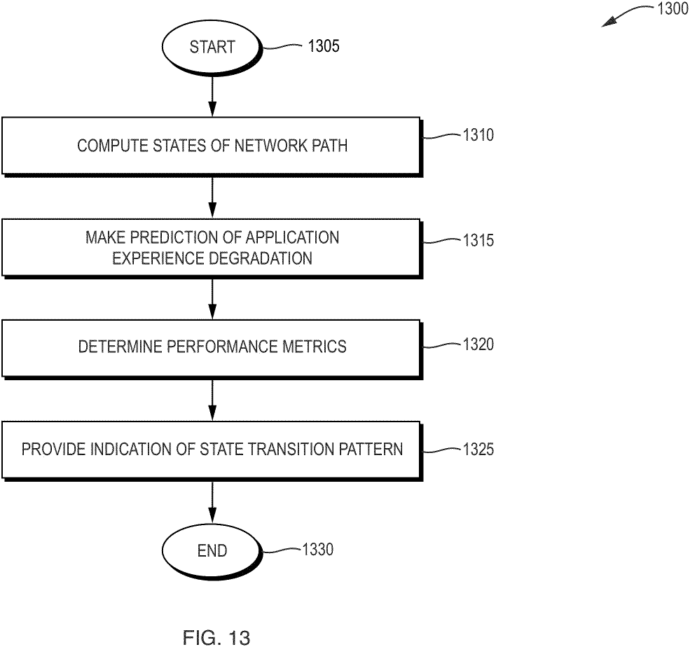

FIG. 13 illustrates an example simplified procedure 1300 (e.g., a method) for performing interpretable forecasting using state transitions in application driven predictive routing, in accordance with one or more embodiments described herein. For example, a non-generic, specifically configured device (e.g., device 200), such as controller for a network (e.g., an SDN controller, an edge router, or other device in communication therewith), may perform procedure 1300 by executing stored instructions (e.g., predictive routing process 248). The procedure 1300 may start at step 1305, and continues to step 1310, where, as described in greater detail above, the device may compute states of a network path associated with an online application by representing time series of telemetry data regarding the network path as discrete values.

At step 1315, as detailed above, the device may make, using a machine learning model, a prediction that a quality of experience metric for the online application will be degraded, based on a particular transition pattern of the states being observed for the network path. In one embodiment, this may entail determining that a service level agreement associated with the online application will be violated by the network path. In some embodiments, the device may also identify the particular transition pattern of the states, based in part on a time window specified by a user. In further embodiments, the device may also receive a wait period for the prediction and specified by a user, wherein the device treats the prediction as true during that wait period. In turn, the device may extend the wait period, when the quality of experience metric was degraded during the wait period for the prediction.

At step 1320, as described in greater detail above, the device may determine one or more performance metrics for the machine learning model with respect to the network path. In various embodiments, the one or more performance metrics for the machine learning model comprise at least one of: a precision of the machine learning model or a recall of the machine learning model.

At step 1325, as detailed above, the device may provide an indication of the particular transition pattern of the states for display, based in part on the one or more performance metrics for the machine learning model with respect to the network path. In one embodiment, the device may do so by providing a cluster map for display that clusters the network path with one or more network paths that exhibit the particular transition pattern of the states before degraded quality of experience metrics. In another embodiment, the device may do so when the one or more performance metrics for the machine learning model exceed a threshold specified by a user. Procedure 1300 then ends at step 1330.

It should be noted that while certain steps within procedure 1300 may be optional as described above, the steps shown in FIG. 13 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for interpretable forecasting using path state transitions in application driven predictive routing, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
computing, by a device, states of a network path associated with an online application by representing time series of telemetry data regarding the network path as discrete values;
making, by the device and using a machine learning model, a prediction that a quality of experience metric for the online application will be degraded, based on a particular transition pattern of the states being observed for the network path;
determining, by the device, one or more performance metrics for the machine learning model with respect to the network path; and
providing, by the device, an indication of the particular transition pattern of the states for display, based in part on the one or more performance metrics for the machine learning model with respect to the network path.

2. The method as in claim 1, wherein making the prediction that the quality of experience metric for the online application will be degraded comprises:
determining that a service level agreement associated with the online application will be violated by the network path.

3. The method as in claim 1, wherein providing the indication of the particular transition pattern of the states for display comprises:
providing a cluster map for display that clusters the network path with one or more network paths that exhibit the particular transition pattern of the states before degraded quality of experience metrics.

4. The method as in claim 1, further comprising:
identifying, by the device, the particular transition pattern of the states, based in part on a time window specified by a user.

5. The method as in claim 1, further comprising:
receiving, at the device, a wait period for the prediction and specified by a user, wherein the device treats the prediction as true during that wait period.

6. The method as in claim 5, further comprising:
making, by the device and after expiration of the wait period for the prediction, a second prediction regarding the quality of experience metric, when the quality of experience metric was not degraded during the wait period for the prediction.

7. The method as in claim 5, further comprising:
extending, by the device, the wait period, when the quality of experience metric was degraded during the wait period for the prediction.

8. The method as in claim 1, wherein the one or more performance metrics for the machine learning model comprise at least one of: a precision of the machine learning model or a recall of the machine learning model.

9. The method as in claim 1, wherein the device provides the indication of the particular transition pattern of the states for display, when the one or more performance metrics for the machine learning model exceed a threshold specified by a user.

10. The method as in claim 1, wherein the online application is a software-as-a-service (SaaS) application.

11. An apparatus, comprising:
one or more network interfaces;
a processor coupled to the one or more network interfaces and configured to execute one or more processes; and
a memory configured to store a process that is executable by the processor, the process when executed configured to:
compute states of a network path associated with an online application by representing time series of telemetry data regarding the network path as discrete values;
make, using a machine learning model, a prediction that a quality of experience metric for the online application will be degraded, based on a particular transition pattern of the states being observed for the network path;
determine one or more performance metrics for the machine learning model with respect to the network path; and
provide an indication of the particular transition pattern of the states for display, based in part on the one or more performance metrics for the machine learning model with respect to the network path.

12. The apparatus as in claim 11, wherein the apparatus makes the prediction that the quality of experience metric for the online application will be degraded by:
determining that a service level agreement associated with the online application will be violated by the network path.

13. The apparatus as in claim 11, wherein the apparatus provides the indication of the particular transition pattern of the states for display by:
providing a cluster map for display that clusters the network path with one or more network paths that exhibit the particular transition pattern of the states before degraded quality of experience metrics.

14. The apparatus as in claim 11, wherein the process when executed is further configured to
identify the particular transition pattern of the states, based in part on a time window specified by a user.

15. The apparatus as in claim 11, wherein the process when executed is further configured to:
receive a wait period for the prediction and specified by a user, wherein the apparatus treats the prediction as true during that wait period.

16. The apparatus as in claim 15, wherein the process when executed is further configured to
make, after expiration of the wait period for the prediction, a second prediction regarding the quality of experience metric, when the quality of experience metric was not degraded during the wait period for the prediction.

17. The apparatus as in claim 15, wherein the process when executed is further configured to:
extend the wait period, when the quality of experience metric was degraded during the wait period for the prediction.

18. The apparatus as in claim 11, wherein the one or more performance metrics for the machine learning model comprise at least one of: a precision of the machine learning model or a recall of the machine learning model.

19. The apparatus as in claim 11, wherein the apparatus provides the indication of the particular transition pattern of the states for display, when the one or more performance metrics for the machine learning model exceed a threshold specified by a user.

20. A tangible, non-transitory, computer-readable medium storing program instructions that cause a device to execute a process comprising:
computing, by the device, states of a network path associated with an online application by representing time series of telemetry data regarding the network path as discrete values;
making, by the device and using a machine learning model, a prediction that a quality of experience metric for the online application will be degraded, based on a particular transition pattern of the states being observed for the network path;
determining, by the device, one or more performance metrics for the machine learning model with respect to the network path; and
providing, by the device, an indication of the particular transition pattern of the states for display, based in part on the one or more performance metrics for the machine learning model with respect to the network path.
